(19) United States
(12) Patent Application Publication
(10) Pub. No.: US 2014/0337215 A1
(43) Pub. Date: Nov. 13, 2014

(54) SYSTEM AND METHOD FOR UPDATING CARDHOLDER PERSONAL DATA WITH AVS SYNCHRONIZATION

(71) Applicant: MASTERCARD INTERNATIONAL INCORPORATED, Purchase, NY (US)

(72) Inventor: Justin Xavier Howe, Oakdale, NY (US)

(73) Assignee: MasterCard International Incorporated, Purchase, NY (US)

(21) Appl. No.: 13/890,414

(22) Filed: May 9, 2013

(51) Int. Cl. G06Q 20/22

(52) U.S. Cl. CPC G06Q 20/22
USPC 705/44; 705/39

(57) ABSTRACT

A computer-implemented method of processing updated payment cardholder personal data. The method includes receiving, by a at least one processing device, updated personal data associated with the payment cardholder; obtaining, by the at least one processing device, data identifying at least one payment system entity with which the payment cardholder has a transaction history; and transmitting, by the at least one processing device, notification of the payment cardholder's personal data update to the identified at least one payment system entity. The receiving, obtaining, and transmitting by the at least one processing device are performed independent of administration by an issuing bank that issued a payment card to a payment cardholder.

### BACKGROUND OF THE DISCLOSURE

The present disclosure relates to updating a cardholder's personal data and, more particularly, to a system and method for propagating a cardholder personal data update and synchronizing an update of cardholder personal data with an address verification system (AVS).

A payment card is a cashless payment device that may be embodied, for example, as a credit card, debit card, contactless RFID-enabled device including a smart card, Near-Field Communication enabled smartphone, electronic mobile wallet or the like. The payment card may be a device, real or virtual, by which the cardholder as payor and/or the source of funds for the payment may be identified.

A payment card may be presented by a cardholder for transacting a payment at a point of sale or from a remote location. In some instances, individuals may repeatedly transact transactions with a single merchant, such as a repeat customer or by way of recurring payments. A repeat transaction may be triggered at regularly scheduled intervals or upon occurrence of an event, such as the balance reaching a predetermined threshold.

It has become common for individuals to enroll with merchants with whom they expect to have repeat transactions for goods and services using a payment card. The enrollment may include providing payment card data and personal data. Once enrolled, when making a transaction, the individual need not reenter the personal data and payment card data, but may be provided with an opportunity to update information. Portions of the personal data may be used to authenticate the individual's authority to make the transaction with the payment card.

During an authentication phase of a transaction, the personal data may be used by authenticating entities to authenticate the transaction. Entities involved in the authentication process may include, for example, the issuing bank that issued the payment card to the cardholder, the merchant, and/or the merchant bank that authorizes payment card transactions and transfers money on behalf of the merchant. In some instances, the issuing bank and the merchant bank may compare personal data associated with the cardholder for verification purposes before authorizing the transaction. However, when the personal data stored by the issuing bank and the merchant bank does not match, such as due to an update of personal data with only one of the authenticating entities, the transaction may be denied.

For some transactions, part of the authentication process includes requesting that a cardholder enter personal data for verification purposes (e.g., with an AVS) at the time of the transaction, such as address or zip code information. The cardholder-entered information may be compared to corresponding personal data stored by an authentication entity, and the authorization of the transaction may be denied if they do not match.

When a cardholder moves and his address changes, attempted transactions may be denied, unless he updates his address with each authentication entity involved in authenticating the transactions. The United States Post Office has devised a centralized database known as the National Change of Address (NCOA) for propagating an address change for the purposes of conventional mail delivery. Businesses may consult the centralized NCOA database in order to update their own databases. However, for the purposes of transaction authorization, the individual is expected to update his personal data information with each authenticating party that will be authenticating his payment card-based transactions.

The process for updating personal data can be tedious and time consuming. What is more, the updating process may be performed haphazardly since individuals do not typically have a comprehensive list of parties that they have enrolled with for future or recurring transactions. When an update is missed, an address verification process may cause denial of an important payment, potentially causing further complications and penalty fees. Thus, there is a need to propagate a cardholder's personal data updates to members of a payment network that are apt to perform transactions with the cardholder's payment card. There is a further need to synchronize updated cardholder personal data with an AVS.

### SUMMARY

In one aspect of the present disclosure a computer-implemented method is provided for processing updated payment cardholder personal data. The method includes receiving updated personal data associated with a payment cardholder, obtaining data identifying at least one payment system entity with which the payment cardholder has a transaction history, and transmitting notification of the payment cardholder's personal data update to the identified at least one payment system entity. The receiving, obtaining, and transmitting are performed by at least one processing device independently of administration by an issuing bank that issued a payment card to the payment cardholder.

In another aspect of the present disclosure, a computer-implemented method is provided for processing updated payment cardholder personal data. The method includes receiving updated personal data associated with a payment cardholder, obtaining data identifying at least one payment system entity with which the payment cardholder has a transaction history, and transmitting identification of each identified payment system entity. The receiving, obtaining, and transmitting are performed by at least one processing device independently of administration by an issuing bank that issued a payment card to the payment cardholder.

In another aspect of the present disclosure, a computer-implemented method is provided for accessing transaction data associated with a transaction between a payment card and a merchant that needs authorization. The transaction data includes identification of the payment card, identification of the merchant, and verification data associated with the payment card that is used to authorize the transaction. The method further includes determining whether alternate personal data associated with a payment cardholder of the payment card is available, and if the alternate personal data is available, replacing, before a process to authorize the transaction, the verification data included in the transaction data with a verification portion of the alternate personal data.

In a further aspect of the disclosure, a system is provided for processing updated payment cardholder personal data. The system includes a memory and a computer device. A service module is provided which is stored in the memory and executable by the computer device. When executed by the computer, the service module is configured to receive updated personal data associated with a payment cardholder, obtain data identifying at least one payment system entity with which the payment cardholder has a transaction history, and transmit notification of the payment cardholder's personal data update to the identified at least one payment system entity. Execution of the service module by the computer device is independent of administration by an issuing bank that issued a payment card to the payment cardholder.

In an additional aspect of the disclosure, a system is provided for processing updated payment cardholder personal data. The system includes a memory, and a computer device. A service module is stored in the memory and executable by the computer to receive updated personal data associated with a payment cardholder, obtain data identifying at least one payment system entity with which the payment cardholder has a transaction history, and transmit identification of each identified payment system entity. Execution of the service module by the computer device is independent of administration by an issuing bank that issued a payment card to the payment cardholder.

In still another aspect of the disclosure, a system is provided for processing updated payment cardholder personal data. The system includes a memory, a computer device, and a service module stored in the memory. The service module is executable by the computer device to access transaction data associated with a transaction between a payment card and a merchant that needs authorization. The transaction data includes identification of the payment card, identification of the merchant, and verification data associated with the payment card that is used to authorize the transaction. The service module further determines whether updated personal data associated with a payment cardholder of the payment card is available. If the updated personal data is available, the service module replaces, before a process to authorize the transaction, the verification data included in the transaction data with a verification portion of the updated personal data.

In a further aspect of the disclosure, at least one computer readable media is provided that includes programmable instructions, which when executed by a processor, cause the processor to receiving updated personal data associated with a payment cardholder, obtain data identifying at least one payment system entity with which the payment cardholder has a transaction history, and transmit notification of the payment cardholder's personal data update to the identified at least one payment system entity. The processor executes the programmable instructions independent of administration by an issuing bank that issued a payment card to the payment cardholder.

In a further aspect of the disclosure, at least one computer readable media is provided that includes programmable instructions, which when executed by a processor, cause the processor to access transaction data associated with a transaction between a payment card and a merchant that needs authorization. The transaction data included identification of the payment card, identification of the merchant, and verification data associated with the payment card that is used to authorize the transaction. The processor is further caused to determine whether updated personal data associated with a payment cardholder of the payment card is available. If the updated personal data is available, the processor is caused to replace, before a process to authorize the transaction, the verification data included in the transaction data with a verification portion of the updated personal data.

A preferred form of the method according to the present disclosure, as well as other embodiments, objects, features and advantages of this disclosure will be apparent from the following detailed description of illustrative embodiments thereof, which is to be read in conjunction with the accompanying drawings.

### BRIEF DESCRIPTION OF THE DRAWINGS

FIG. 1 provides a schematical diagram of a card-based payment system that provides a personal data update (PDU) service and/or an address verification synchronization (AVS) service;

FIG. 2 provides a block diagram of data structures used by a server of the payment system that implements the PDU and/or AVS service;

FIG. 3 provides a block diagram of software modules executed by the server to provide the PDU and/or AVS services;

FIGS. 4A-4C provide a flow diagram depicting a method performed by an Enrollment and Validation Module of the software modules shown in FIG. 3;

FIGS. 5A-5C provide flow diagrams depicting a method performed by a Notification Module of the software modules shown in FIG. 3;

FIGS. 6A-6C provide flow diagrams depicting a method performed by an Address Verification Synchronization (AVS Synch) Module of the software modules shown in FIG. 3;

FIG. 7 provides a flow diagram depicting a further method performed by the AVS Synch Module; and

FIG. 8 provides a schematical diagram of an embodiment of the card-based payment system that provides the PDU and AVS services.

### DETAILED DESCRIPTION OF THE DISCLOSURE

A payment card based payment system is provided that includes at least one payment network. A server is provided that implements a Personal Data Update (PDU) service that may operate independent of control by an issuing bank that issued the payment card to a cardholder. Cardholders and/or merchants and/or other entities may enroll with the PDU service. The server may receive an update of personal data associated with a cardholder and propagate the information to other entities, such as identified merchants or merchant banks with which the cardholder shares a transaction history. Additionally, or alternatively, the server may provide a list of the identified merchants or merchant banks to the cardholder in order that the cardholder may propagate the information or provide informed permission for the server to propagate the information. Propagation of the cardholder's personal data update may be for the purpose of, for example, updating records used for billing or transaction authorization.

Additionally, or alternatively, the server may provide an Address Verification Service (AVS) Synchronization (Synch) service, including, during a transaction, substituting verification information submitted during a transaction with alternate data, which may be extracted from the updated cardholder personal data or historical information related to the cardholder's personal data to avert denial of authorization. The historical information may be used to determine the validity of the replacement before allowing it. The term AVS as used in the present disclosure is not limited to an address verification system, but can further refer to a system that uses a cardholder's personal data to verify a transaction, where the personal data is not limited to address data.

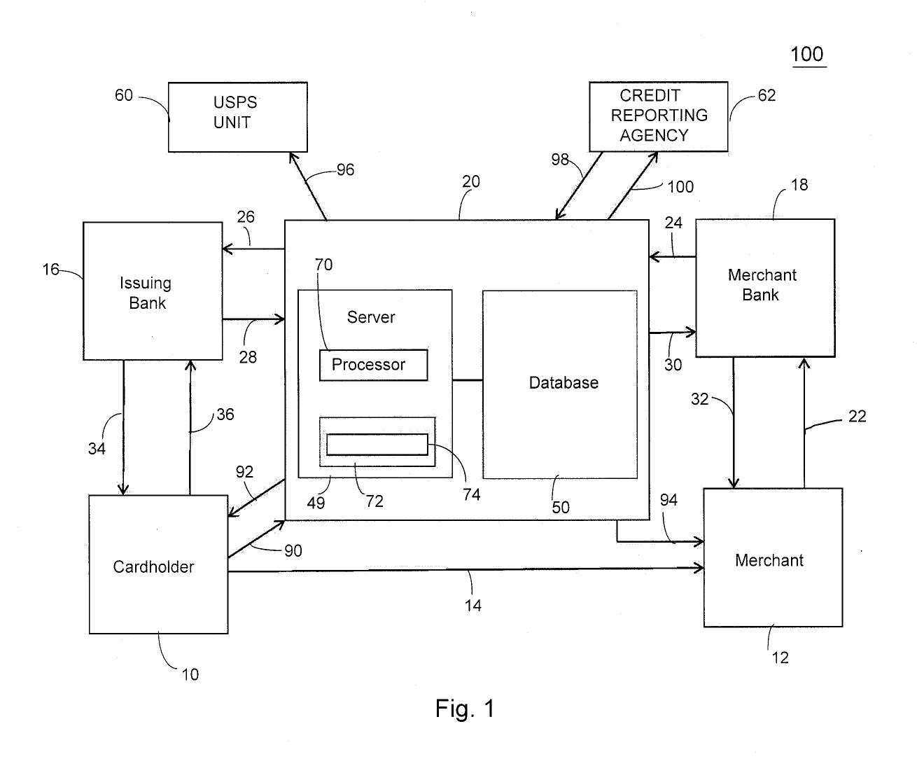

Referring first to FIG. 1, an example card-based payment system 100 is shown. A cardholder 10 may initiate a transaction by presenting his payments card to a merchant 12 for the purchase of goods and/or services, as indicated by arrow 14. The presentation of the payment card to the merchant 12 may be at a point of sale (POS) or from a remote location, such as an online purchase performed by the cardholder 10 in which the cardholder 10 operates a computer terminal to access a website operated by the merchant 12 and enters the payment card information to make the online purchase. The presentation may also be performed automatically as a recurring payment with the cardholder's authorization.

It will be understood that prior to the occurrence of transaction 14, cardholder 10 was issued a card by issuing bank 16. Moreover, it will be understood that merchant 12 established a relationship with a merchant bank 18, thereby allowing merchant 12 to receive payment for goods and/or services via payment cards. The merchant banks 18 and issuing banks 16 may participate in various payment networks, including payment network 20. One such payment network is operated by MasterCard International Incorporated, the assignee of the present invention.

As readily understandable to one having skill in the art, each component, including the cardholder 10, merchant 12, issuing bank 16, merchant bank 18, payment network 20, USPS Unit 60, and Credit Reporting Agency 62, may include a digital computing system operated by the cardholder, merchant, issuing bank, merchant bank, payment network, or administrator thereof. Each computing system may have at least one processor, storage device, and communication device for enabling digital communication as indicated by the arrows shown between the components 10, 12, 16, 18, 20, 60 and 62. The components 10, 12, 16, 18, 20, 60 and 62 may further include at least one means for communicating information to an operator (e.g., a display device or speaker) and means for receiving information from an operator (e.g., a user input device, such as a keypad or touch sensitive display device). Additionally, the payment network 20 may communicate with a plurality of cardholders 10, merchants 12, issuing banks 16, merchant banks 18, USPS Units 60, and Credit Reporting Agencies 62.

For example, a cardholder 10 may operate a processing device, such as a computer, smartphone, tablet, that includes a processor; a storage device; a display device, such as an LCD screen, touch screen, or plasma display; and a user input device, such as a virtual or physical keyboard, microphone, or touchscreen. The cardholder 10 may operate the processing device to exchange data with the payment network 20 remotely, e.g., via a website link to the payment network 20, and/or via software executable by the processor, such as downloaded via the Internet, e.g., in the form of a smartphone app. The cardholder 10 may transmit data to the payment network 20 via the user input device and view data exchanged with payment network 20 via the display device.

Payment network 20 provides a payment system using payment cards associated with the payment network 20 as cash-substitutes for the purpose of enabling payment between members of its network. Such members may include, for example, participating cardholders and merchants. Cardholders are individuals or entities that were issued a payment card by an issuing bank that is enrolled with the payment network 20 that the payment card is associated with. Payment network 20 may enroll a variety of merchants, merchant banks, and issuing banks to participate in its network.

For simplicity, “payment card” as used herein includes a cashless payment device, real or virtual, such as, for example and without limitation, a credit card, a debit card (signature or PIN enabled), a contactless RFID-enabled device including a smart card Near-Field Communication (NFC) enabled smartphone, an electronic mobile wallet, or the like. The payment card may identify the cardholder as payor and/or an account, or source of funds, from which the payment may be made.

During a transaction using a payment card, payment card data and/or personal data associated with the cardholder are transferred in transaction messages. Payment card data can include authorization and clearing data associated with the payment card, such as a card ID number identifying the payment card, expiration date, and card verification value code. Personal data may include billing and/or authorization data associated with the cardholder, such as contact information, which may include, for example, e-mail address, residential or mailing address, zip code, telephone number; social security number (SSN); driver's license number; birthdate; etc. While some of the information, such as birthdate and SSN, is static, other information, particularly contact information, may be dynamic, for example, changing each time the cardholder moves to a new residence.

After presentation of a card to merchant 12 by cardholder 10, an authorization phase of the transaction is performed. The authorization phase may include validating the payment card or the cardholder's authority to use it, and/or confirming that the cardholder has a sufficient line of credit to cover the proposed payment. Merchant 12 sends an authorization request (indicated by arrow 22) to merchant bank 18. In turn, merchant bank 18 communicates with payment network 20 (indicated by arrow 24), and network 20 communicates with the issuing bank 16 (indicated by arrow 26) to determine whether the cardholder is authorized to make the transaction in question. An approval or disapproval of the authorization request is thereafter transmitted back to merchant 12 (indicated by arrows 28, 30 and 32). Merchant 12 thereafter either completes or cancels the transaction based upon the response to the authorization request. Verification data, such as cardholder address or zip code, may be transmitted with transaction messages indicated by arrows 22, 24, and 26.

If the transaction indicated by arrow 14 is approved, a clearance phase of the transaction is commenced. During the clearance phase, funds are moved from the issuing bank 16 to the merchant bank 18. Specifically, the transaction amount is sent from issuing bank 16 through network 20 to bank 18. This transaction amount, minus certain fees, will thereafter be deposited within a bank account belonging to merchant 12. Issuing bank 16 thereafter bills cardholder 10 (indicated by arrow 34) for the amount of such transaction, and cardholder 10 follows by a submission of payment(s) (as indicated by arrow 36) to issuing bank 16. This submission of payment(s) (as indicated by arrow 36) by cardholder 10 may be automated (e.g., in the case of debit transactions), may be initiated by the cardholder 10 for the exact amount matching costs of purchases during the statement period (e.g., charge cards or credit balances paid in full), and/or may be submitted (in part or in whole) over a period of time that thereby reflects the costs of the purchases plus financing charges agreed upon beforehand between the cardholder 10 and the cardholder's issuing bank 16 (e.g., revolving credit balances).

With continued reference to FIG. 1, payment network 20 includes a server 49 that manages the processing, transfer of information, and communication represented by arrows 24, 26, 28, 30. Server 49 may provide a website via which it exchanges information with remote processing devices, e.g., operated by the cardholder 10, merchant bank 18, or issuing bank 16. In the embodiment shown in FIG. 1, the server 49 further implements the PDU service and/or the AVS Synch service.

The server 49 includes a processor 70, storage device 72 that includes computer readable memory to store programmable instructions that are executable by processor 70, and database 50 that is accessible by server 49. One of skill in the art will appreciate that the instructions stored on the storage device 72 are accessible by the processor 70, which preferably includes a central processing unit (CPU), and that when executed causes the processor 70 to implement the steps of the methods described herein. The memory 72 can include any combination of random access memory (RAM), read only memory (ROM), a storage device including a hard drive, or a portable, removable computer readable medium, such as a compact disk (CD) or a flash memory, or a combination thereof. Memory 72 may be provided at the same physical location as processor 70, and/or may be provided at a different location remote from the location of processor 70. Software Service Modules 74 are stored by storage device 72. Server 49 is configured to provide the PDU service and/or AVS Synch service by way of execution by processor 70 of one or more of the modules included with Service Modules 74.

Database 50 is accessible by the processor 70 for storing and making available to the processor 70 data stored therein. Database 50 may include one or more storage devices which may be linked to or independent from one another, and which may be stored local to the server 49, such as via physical connections with processor 70, or remote from server 49, such as via wireless connections with processor 70. All or a portion of database 50 may be maintained by a third party and/or configured as cloud storage.

The cardholders 10, merchants 12, merchant banks 18, issuing banks 16, and server 49 of payment network, may exchange data or provide data that can be exchanged by the other entities. Communication between the entities may be via wired or wireless communication. Accordingly, the terms “receiving,” “obtaining,” and “transmitting” may refer to an actual exchange of data by sending the data via a communication means, accessing data, allowing the access of data, or a combination thereof.

In addition to performing traditional functions that are performed by a traditional payment network and that are known to one skilled in the art, server 49 performs functions for providing the PDU and/or AVS synch services. This includes managing enrollment to the service by subscribers to the service, such as cardholders, merchants, merchant banks and/or issuing banks. Subscribers may select which of the services they want to use and may select and customize features of the services they have selected. Some examples, without limitation thereto, of selections that may be made by subscribers to either of the services are now described.

By enrolling with the PDU service, a cardholder 10 may have personal data updates transmitted to other payment system entities on the cardholder's behalf. The subscribing cardholder 10 may select whether to have his personal data automatically propagated to selected or all enrolled (or non-enrolled) entities, and/or to propagate it to all or selected entities only upon receiving permission from the cardholder 10. In one embodiment, the cardholder may grant permission in an explicit fashion. It is further envisioned that the cardholder may grant permission in an implied fashion. The cardholder 10 may communicate the selected entities digitally, in writing, or verbally. The selections may be made by identifying the merchants or specifying criteria to be satisfied.

A payment system entity, such as a merchant 12, merchant bank 18, or issuing bank 16, that is a subscriber to the PDU service may subscribe to receive updated personal data for all cardholders 10 who are subscribed, or only for selected cardholders, e.g., that satisfy certain criteria. Updated personal data includes personal data that is newly added for the first time (e.g., at enrollment), or newly added data that updates or supplements existing personal data.

With respect to the AVS Synch service, a subscribing cardholder 10 may enable or disable the service manually, or automatically, in accordance with certain criteria, such as the identity of the merchant 12, the value of the transaction, or the date of the transaction. A merchant 12, merchant bank 18, or issuing bank 16 that is a subscriber may subscribe to allow the service to be performed, for example without limitation, for all transactions upon the occurrence of a single authorization failure, for all transactions in which a cardholder is not a subscriber to the PDU service, or for selected cardholders 10 for which PDU is not performed because they do not satisfy certain criteria.

Enrollment may be available, such as via a website, by telephone, or by conventional mail. Additionally, or alternatively, offers to enroll may be proffered under particular circumstance, such as when registering with a credit bureau to request one-time or periodic credit reports, when registering with a service to update address information, e.g., with the National Change of Address (NCOA) service offered by the USPS, or when applying for a payment card or line of credit.

It should be recognized that the components illustrated in FIG. 1 are exemplary only, and it is contemplated that the methods described herein may be implemented by various combinations of distributed hardware, software, firmware, circuitry, and/or processors and associated memory, for example, as well as other components known to those of ordinary skill in the art.

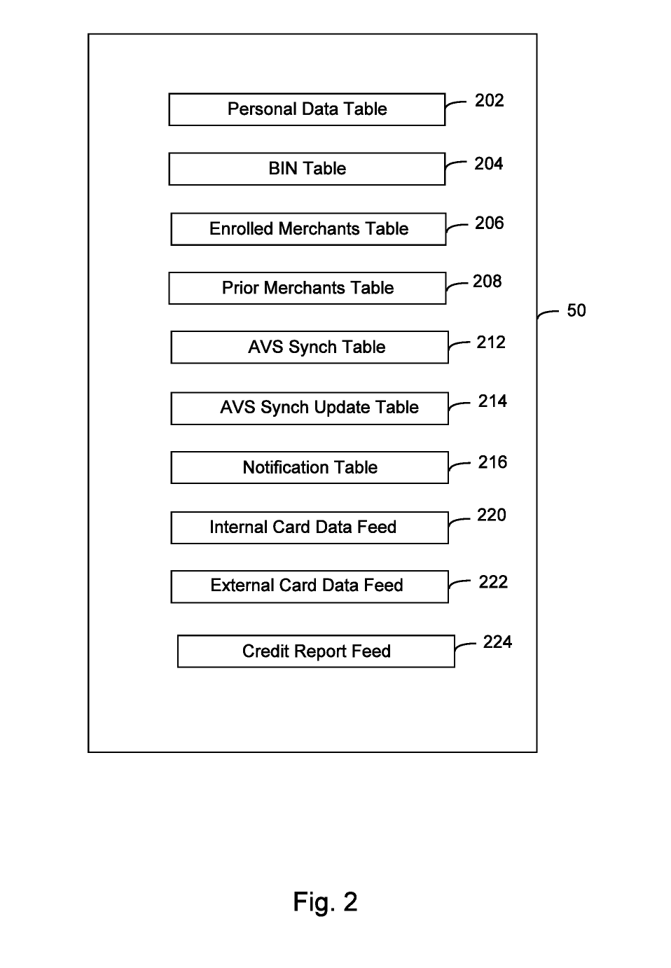

With reference to FIG. 2, the database 50 stores data structures that are used for implementing the PDU and/or AVS Synch service. Some of the data structures may additionally be used for providing traditional functions of a traditional payment network server. The data structures are described as tables or feeds, but the disclosure is not limited thereto. Those having skill in the art will appreciate that other data structures for storing a plurality of data items may be used, such as trees, graphs, lists, etc. The data structures stored by database 50 include a Personal Data Table 202, BIN Table 204, Enrolled Merchants Table 206, Prior Merchants Table 208, Address Verification system (AVS) Synch Table 212, AVS Synch Update Table 214, Notification Table 216, an Internal Card Data Feed 220, an External Card Data Feed 222, and a Credit Report Feed 224.

Personal Data Table 202 stores, in association with respective payment cards associated with the payment network 20, card data associated with a payment card and personal data associated with the payment card's cardholder. The card data may include a unique identifier, such as a personal account number (PAN) that identifies the account to which transactions using the payment card can be assessed. The PAN may be, for example, the account number on a credit, debit, or charge card. This information may be encoded on a magnetic strip or on an RFID chip that enables the transaction device to interact with POS devices.

The personal data includes information about the cardholder's name (where here cardholder refers to the person that holds the payment card, as opposed to the digital entity); SSN; birthdate; contact information, such as e-mail address, telephone number(s), and address data, which may include zip code, and/or an identifier that identifies digital device(s) used by the cardholder. The address data may include the cardholder's current (or most recent) address, with an associated date on which it was last updated, Cardholder_Last_Update_Date. Additionally, the address data may include address history data, which may include one or more previous addresses that are associated with the cardholder. The address history data may be entered by the cardholder; or may include address data for an old address or multiple old addresses that were either retained when the cardholder updated his address with a new address; or were obtained from a different source, such as the USPS, a credit report or Credit Reporting Agency 62, or direct marketing lists or list providers. Each historical address included with the address history data may have associated with it a Last_{—} Historical_Address_{—} Update_Date that indicates the date that the associated historical address was last updated.

The personal data, such as the contact data or address data, may correspond to verification data that is included in a transaction message transmitted during a transaction, such as shown at arrows 14, 22, 24 and/or 26. The verification data in the transaction message is compared with equivalent verification data stored by the merchant 12, merchant bank 18, or issuing bank 16. The type of data used for verification data may vary depending on the nature of the transaction or the identity of the merchant 12, merchant bank 18, issuing bank 16, or payment network 20, and may include, for example, an entire address or a five digit zip code. Authorization of the transaction requires that the verification data in the transaction message match the verification data stored by the entity (12, 16, and/or 18) that is performing an authorization action.

The personal data and card data may be provided by the cardholder 10 (now referring to the person and/or digital entity), such as by entering the data via a website, a person filling out a printed form or voice form, or providing the information verbally by phone after which the data is entered by administrative personnel. The personal data and card data may alternatively be provided by a party other than the cardholder 10, such as the issuing bank 16, merchant 12, merchant bank 18, or a third party, such as a Credit Reporting Agency 62 or a data aggregating entity. The server 49 may contact the cardholder 10 (e.g., by e-mail, conventional mail, or phone) to verify information provided by a non-cardholder party.

The Personal Data Table 202 further includes a variety of flags. An Old_Address_Verified_Flag is associated with each old address included in the address history data to indicate whether that address has been verified or not. Also, a Payment_Card_Validated_Flag indicates whether the payment card's verification code has been verified. A Card_In_CR_Flag indicates whether the payment card is reported in a credit report.

The BIN Table 204 stores card data associated with each payment card, including the card's bank identification number (BIN), which are the first six digits of the card's PAN; a card classification (e.g., consumer credit, consumer debit, commercial); the card's issuing bank; and the Issuer_Last_Update_Date, which is the date that the issuing bank last updated information stored in the Personal Data Table 202 or received an update. The Issuer_Last_Update_Date may indicate a date at which information stored by the issuing bank 16, such as contact information for the cardholder, and particularly the portion that is used as verification data, is synchronized with the equivalent data stored in the Personal Data Table 202.

The Enrolled Merchants Table 206 may include a list of merchants 12 that are enrolled with the payment network 20. An enrolled merchant 12 and/or its associated merchant bank 16 may store personal data for cardholders 10 with which it transacts transactions, especially those cardholders 10 with which it expects repeat sales of or payments for goods or services. The personal data usually includes verification data, which may be all or a portion of the cardholder's current address, for example; an Enrolled_Flag that indicates whether the merchant 12 has enrolled with the PDU service and/or for AVS synchronization; and a Merchant_Last_Update_Date, which indicates the date that the merchant 12 (or associated merchant bank 18) last updated information (or received updated information) stored in the Personal Data Table 202. The Merchant_Last_Update_Date may indicate the date that information stored by the merchant 12 (or associated merchant bank 18), such as contact information for the cardholder, and particularly the portion that is used as verification data, was synchronized with the equivalent data stored in the Personal Data Table 202.

The Prior Merchants Table 208 may store historical merchant data in association with cardholders 10 and the associated payment cards. The historical merchant data may be tracked and/or stored only for cardholders 10 that have enrolled with the PDU service and/or automatic AVS synchronization. The historical merchant data identifies merchants 12 that the cardholder 10 has had transactions with in the past, dating back to some predetermined date threshold. The historical merchant data may be derived from the Internal Card Data Feed 220 and/or the External Card Data Feed 222. The Prior Merchants Table 208 may include a Notification_Flag that indicates whether the merchant 12 has been notified about an update of a cardholder's personal data, e.g., an update to address data or verification data. The Notification_Flag may be reset to “N” when an update for cardholder personal data is received, and set to “Y” when a merchant 16 is notified of the update.

The Notification Table 216 stores data about personal data updates for each payment card that is enrolled with the payment network 20 for the PDU service. The personal data update data includes a unique card identifier identifying each payment card enrolled and the updated personal data that has been updated. It may include the historical personal data. The historical personal data may be used to verify data before a replacement is performed, or to replace data.

The Notification Table 216 may further include information for notifying enrolled entities of updates to automatic billing data, such for supporting an automatic billing update (ABU) service. Entities that may receive notification are entities included with the payment network system 100, such as merchants 12, merchant banks 18, and issuing banks 16. A notified merchant 12 may independently notify its merchant bank 18. Notifications for updated personal data may be sent together with updates for automatic billing, or separately therefrom. Automatic billing data may include, for example, historical identification numbers that were previously associated with the payment card account but no longer are; and the payment card's expiration date. Merchants 12 or other payment system entities that have enrolled with the payment network 20 for the PDU service may have rights to access the Notification Table 216.

The AVS Synch Table 212 stores transaction update data for unsynchronized transactions between each cardholder 10 and a merchant 12, including, for example, a payment card identifier identifying the payment card used in the transaction; a merchant identifier identifying the merchant 12 involved in the transaction; and update data. The transaction update data includes, for example, the merchant's Merchant_Last_Update_Date, the cardholder's Cardholder_Last_Update_Date, and the issuing bank's Issuer_Last_Update_Date. The transaction update data may be provided, for example, by the merchant 12, server 49, and issuing bank 16, respectively, or based on their activity with the PDU service. The transaction update data is determined to be unsynchronized when the Cardholder_Last_Update_Date is in between the Merchant_Last_Update_Date and the Issuer_Last_Update_Date.

The AVS Synch Update Table 214 stores daily transaction update data for transactions between the cardholders 10 and merchants 12 of the payment network system 100, including the Cardholder_Last_Update_Date, the Merchant_Last_Update_Date and the Issuer_Last_Update_Date. The data is purged on a daily basis after determining which transaction records are unsynchronized and entering the unsynchronized transaction records in the AVS Synch Table 212.

Internal Card Data Feed 220 includes transaction data for transactions across a wide variety of merchants 12 that are enrolled with the payment network 20. The transaction data can be data that is tracked in real time or periodically, such as daily or weekly, and the tracked data may be stored in database 50 in real time, in response to an event, or periodically.

External Card Data Feed 222 includes transaction data regarding payment transactions across a wide variety of merchants that are enrolled with other payment networks or financial institutes. This data may be tracked by a third party and provided to the payment network 20, such as in accordance with a financial or symbiotic arrangement. The tracking and storing of the external card data may be in real time, in response to an event, or periodical.

Credit Report Feed 224 includes credit report data that was extracted or provided from one or more credit reports and/or Credit Reporting Agencies 62. The credit report data may include, for example, a cardholder's SSN, identification of each of the cardholder's payment cards and/or other credit accounts that was available from the credit reporting agencies or third parties, the name of the issuing bank or lending bank, the cardholder's current address, and previous addresses associated with the cardholder. A Credit_Report_Flag is provided that indicates whether a credit report for the user was obtained and accessed.

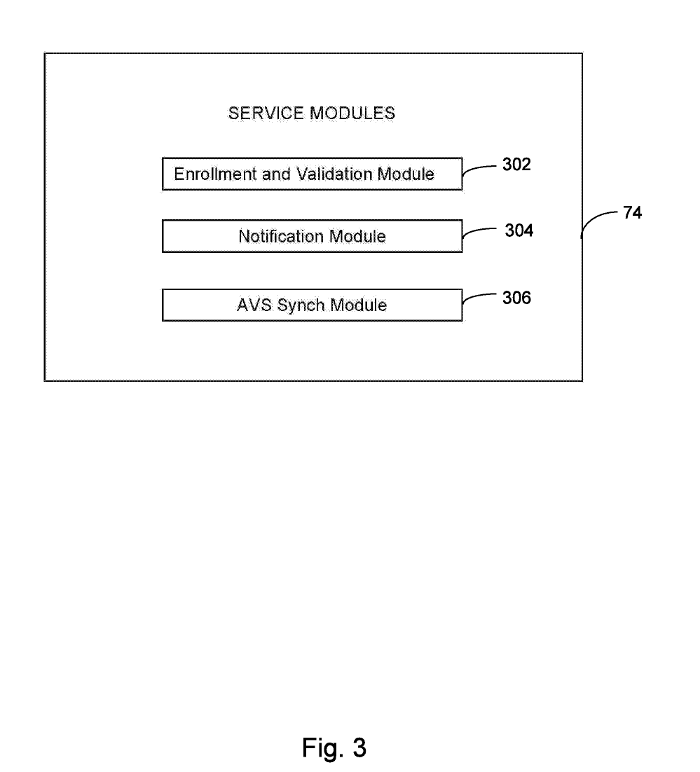

With reference to FIG. 3, Service Module 74 is shown, including software modules that are executable by processor 70 for performing the disclosed method. The modules shown include an Enrollment and Validation Module 302, a Notification Module 304, and an AVS Synch Module 306. Processor 70 executes a combination of one or more of the modules included in Service Module 74 to provide the PDU and/or AVS Synch services, as described in greater detail below.

Processor 70 executes the Service Module 74, including modules 302, 304 and 306, independent of administration from an issuing bank 16. Administration herein refers to human administration or administration by a different processor. Such administration may include direct or indirect, whether full or partial, control, oversight, management, governance, supervision or the like, of the execution, operation, or use. Processor 70 is administered independently of an issuing bank 16 such that it can operate without receiving input data from, or outputting data to, an issuing bank 16.

Accordingly, in the course of executing any of the modules included in Service Module 74, processor 70 may exchange information with other entities of the payment system 100 and perform processing functions without the need for permission from an issuing bank 16, being controlled by an issuing bank 16, receiving input from an issuing bank 16, or providing output to the issuing bank 16.

The software modules include programmable instructions, which can be stored in an appropriate type of tangible computer readable medium for access and execution by processor 70 for performing the method and steps described herein.

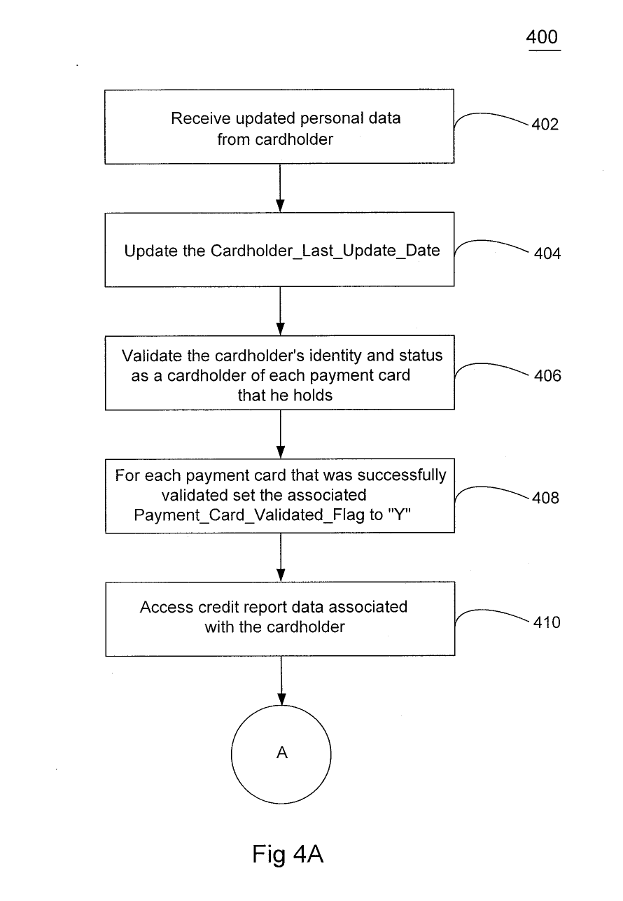

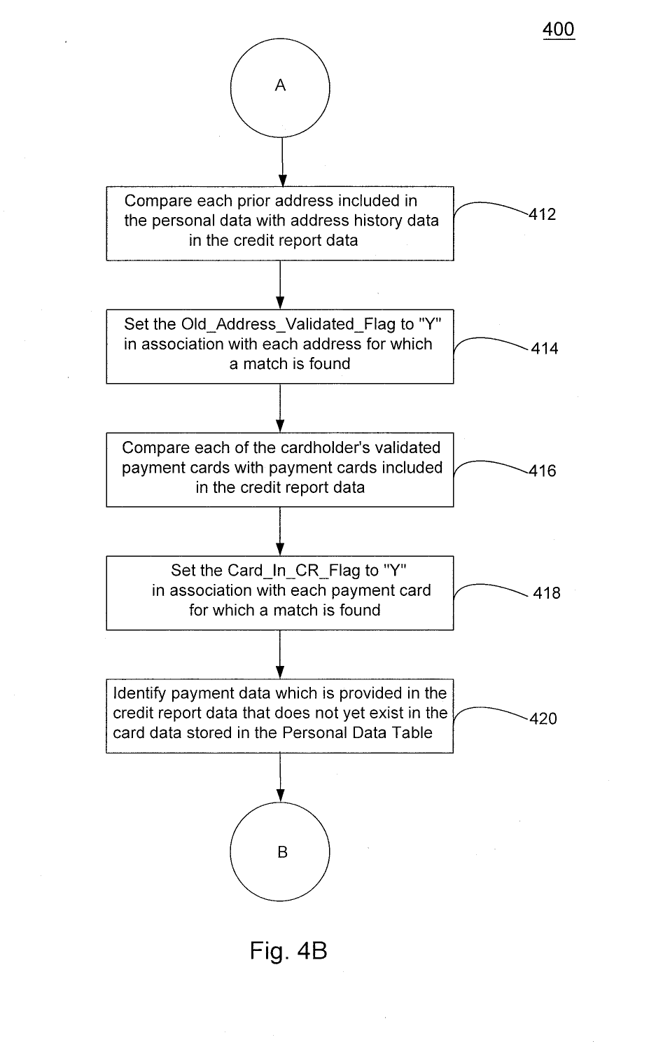

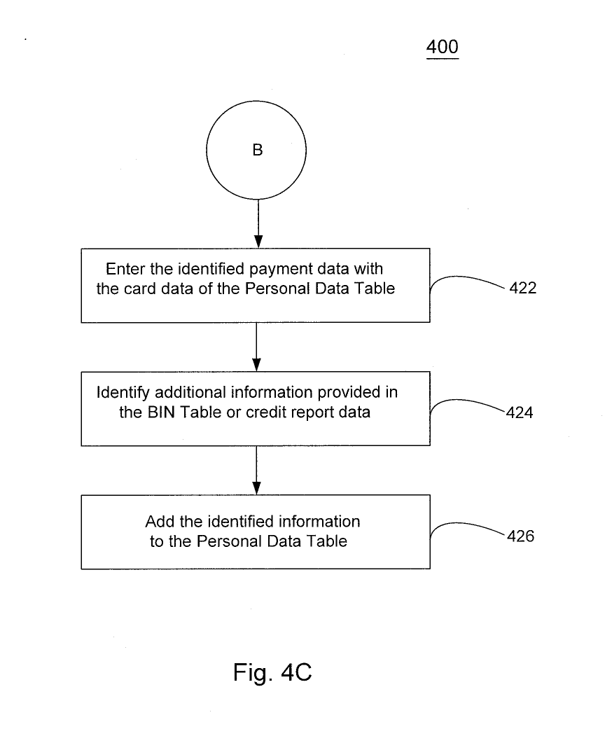

An example of operation of the Enrollment and Validation Module 302 is shown by way of flow diagram 400 displayed in FIGS. 4A-4B. Enrollment and Validation Module 302 is activated when a cardholder 10 enrolls with the PDU and/or AVS Synch services or updates his personal data. Enrollment and Validation Module 302 accesses other data structures, such as the BIN Table 204 and the Credit Report Feed 224 to validate data stored in the Personal Data Table 202 and/or supplement it with additional data. The steps are provided by way of example and are not limiting.

At step 402, upon authentication (e.g., via using a user name and authentication key, such as a password, pin, or biometric identification data) a cardholder 10 accesses the payment network 20 and enters and/or updates personal data. The data may be entered by the cardholder 10 by accessing the web site provided by server 49 or by relaying the information, e.g., by conventional mail, fax, e-mail, or telephone to an administrator of the payment network 20, wherein the data is entered by the administrator so that it is stored in Personal Data Table 202.

At step 404, the Cardholder_Last_Update_Date is updated by the server 49 with the date on which the cardholder provided the information or updated the information. The Cardholder_Last_Update_Date thus reflects the date on which the cardholder's address data was last updated or verified as current. The Enrollment and Validation Module 302 may decide to update the Cardholder_Last_Update_Date based on an actual address update or an explicit verification by the cardholder that the address information is current. Explicit verification may include requiring the cardholder to affirmatively state, such as by an affirmative click, or written or oral statement, that the address information is current. It is also envisioned that the Enrollment and Validation Module 302 may decide to update the Cardholder_Last_Update_Date when the cardholder has implied verification that the address information is current, such as by accessing his personal data without changing his address data.

At step 406, the Enrollment and Validation Module 302 may validate the cardholder's identity and status as a cardholder of each payment card that he holds. The validation process may include, for example and without limitation, prompting the user to provide a card verification code, such as a CVC or CVC2 for each payment card held by the cardholder that the cardholder intends to validate. After verifying the card verification code, the server 49 then transacts a test transaction on each of the payment cards being validated. The cardholder 10 or Enrollment and Validation Module 302 verify that the test transaction was successfully transacted, such as by confirming the amount transacted in the test transaction. This step may be performed by server 49 or a third party.

At step 408, for each payment card that was successfully validated, the Enrollment and Validation Module 302 sets the associated Payment_Card_Validated_Flag to “Y.”

At step 410, the Enrollment and Validation Module 302 accesses the Credit Report Feed 224 using the cardholder's personal data, e.g., SSN, to access credit report data associated with the cardholder.

At step 412, the Enrollment and Validation Module 302 compares each prior address included in the personal data with address history data accessed via the Credit Report Feed 224. At step 414, for each address included in the address history data that substantially matches an address accessed via the Credit Report Feed 224, the Old_Address_Validated_{—} Flag associated with that address is set to “Y.” One having skill in the art will be familiar with techniques for determining whether or not the addresses substantially match one another.

At step 416, the Enrollment and Validation Module 302 compares each of the cardholder's validated payment cards with payment cards included in the Credit Report Feed 224.

At step 418, for each payment card included in the card data of the Personal Data Table 202 that substantially matches a payment card included in the Credit Report Feed 224, the Card_In_CR_Flag is set to “Y.”

At step 420, the Enrollment and Validation Module 302 identifies payment data which is provided in the Credit Report Feed 224 but does not yet exist in the card data stored in the Personal Data Table 202. The payment data may include payment cards and other payment accounts, such as for installment loans (e.g., mortgage and car loans), subscriptions, repeating online payments (e.g., utilities) and the like. At step 422, the Enrollment and Validation Module 302 enters the identified payment data with the card data of the Personal Data Table 202.

In steps 414-420, where the cardholder is a private individual, the Enrollment and Validation Module 302 may ignore card data or payment data related to commercial or corporate accounts or credit loans that are not related to the cardholder. Similarly, where the cardholder is a corporate entity or other commercial entity, then card data or payment data related to private individuals may be ignored.

At step 424, additional information for each payment card or other payment account stored with the card data of the Personal Data Table 202 is culled from the BIN Table 204 or Credit Report Feed 224. At step 426, the identified additional information is added to the card data associated with the payment card and payment accounts in the Personal Data Table 202. The additional information may include, for example, the issuing bank 16 that issued the payment card or the financial institution that issued the loan.

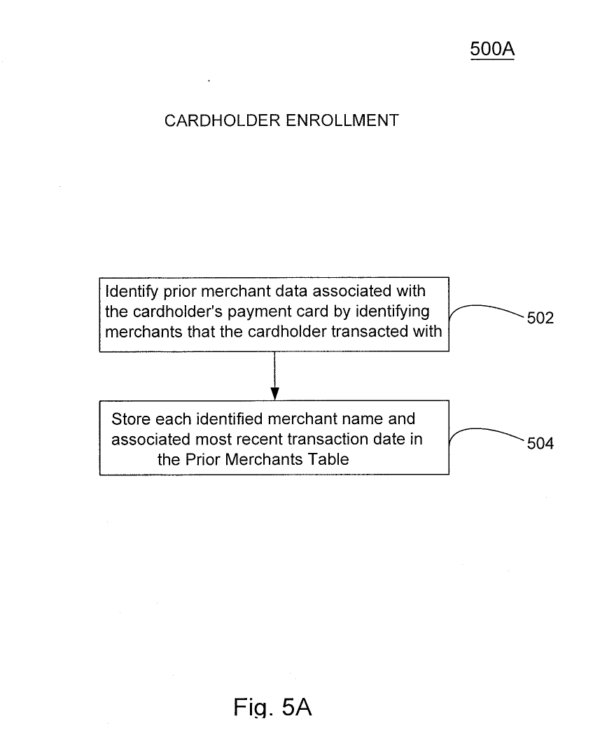

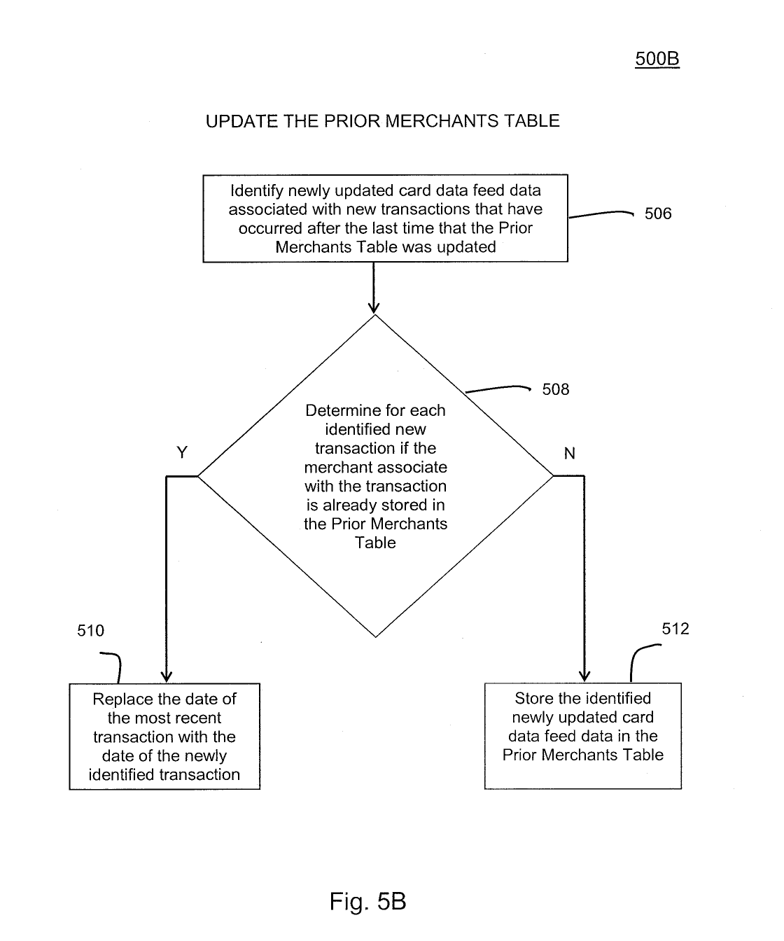

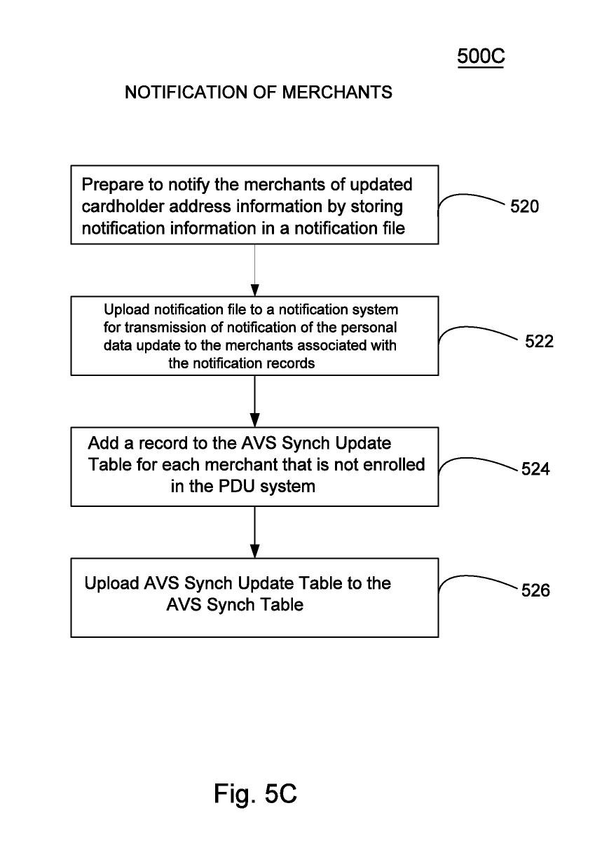

With reference to FIGS. 5A-5C, a method is shown by way of flow diagrams 500A, 500B and 500C to show an example of operation of the Notification Module 304. The steps are provided by way of example and are not limiting.

With reference to FIGS. 5A and 5B, methods are shown for setting up and continuing to update data associated with prior merchants and recent transactions. Upon cardholder enrollment, the Prior Merchants Table 208 is populated with transaction history data for each payment card in the Personal Data Table 202 that is associated with the cardholder 10. After the Prior Merchants Table 208 is populated, it is maintained by updating it periodically or upon the occurrence of an event. Flowchart 500 displayed in FIG. 5A shows an example of operation of the Notification Module 304 with respect to setting up and maintaining the Prior Merchants Table 208.

Step 502 is executed in association with cardholder enrollment. When a cardholder 10 enrolls a payment card with the PDU service or AVS Synch service, the Notification Module 304 identifies transaction history data associated with the cardholder's payment card by identifying merchants 12 with whom the cardholder 10 has transacted. The Notification Module 304 may monitor transactions transacted by the payment card or cardholder 10. An example of monitoring such transactions may include identifying the transaction history data for the payment card by consulting the card data feed information associated with that payment card that is available in the Internal Card Data Feed 220 and/or the External Card Data Feed 222. Such monitoring may include monitoring merchants 12 that have transacted transactions with the payment card and the date of the transaction.

The first time that transaction history data is identified for a payment card, the Notification Module 304 may consult the card data feed information for a time period that spans between the most current date/time for which card data feed information is available, back to a selected start date/time that marks a beginning of the transaction history data time period for which transaction history data is to be stored, e.g., five years prior to the current enrollment date/time. In one embodiment, the transaction history data time period and the start date/time is selectable by the cardholder 10, while in another embodiment, it may be fixed or determined by the PDU Service. The Notification Module 304 identifies the most recent transaction made with each merchant 12 using the payment card within the transaction history data time period. At step 504, the Notification Module 304 stores each identified merchant name and associated most recent transaction date in the Prior Merchants Table 208.

With reference to FIG. 5B, once it is populated, at step 506, the Prior Merchants Table 208 is updated, either periodically (e.g., daily or monthly) or in response to the occurrence of an event, by continuing to monitor the card feed data information. The Prior Merchants Table 208 may be updated for the time period spanning from the current date/time back to the most recent update of the Prior Merchants Table 208. Examples of an event that may trigger an update of the Prior Merchants Table 208 include the credit balance or transaction amount superseding a threshold value, where the threshold value may be selectable, e.g., by the cardholder 10; upon transacting any transaction, or a particular type of transaction using the payment card; and/or accessing or updating by the cardholder 10 his personal data or card data stored in the Personal Data Table 302. An example of steps to update the Prior Merchants Table 208 is shown in steps 508-512.

At step 506, the Notification Module 304 accesses the card data feed information that is available in the Internal Card Data Feed 220 and/or the External Card Data Feed 222 and identifies newly updated card data feed data associated with new transactions that have occurred after the last time that the Prior Merchants Table 208 was updated. At determination step 508, the Notification Module 304 determines for each identified new transaction if the merchant 12 associated with the transaction is already stored in the Prior Merchants Table 208. If the determination is “Y,” then at step 510, the Notification Module 304 replaces the date of the most recent transaction with the date of the newly identified transaction. If the determination is “N,” then at step 512, the Notification Module 304 stores the identified newly updated card data feed data in the Prior Merchants Table 208, including the merchant name and transaction data associated with the identified new transactions.

Accordingly, the Prior Merchants Table 208 is updated to store current, updated data identifying every merchant 12 with whom the cardholder 10 transacts, back to the selected start date, including storing the most recent date that a transaction was transacted with the merchant 12.

In an embodiment, the Notification Module 304 presents the cardholder 10 with a list of the prior merchants stored in the Prior Merchants Table 208 in association with the cardholder's payment card together with the date of the last successfully transacted transaction. The cardholder 10 may use the information provided in the list to update his own records and/or notify the merchants 12 in the event that the cardholder changed addresses.

The list provided to the cardholder 10 may include all merchants 12 in the Prior Merchants Table 208, or the list may be filtered by a factor or combination of factors, such as, but not limited to: merchants 12 that are enrolled in the PDU service, merchants 12 that have not successfully transacted a transaction since the date of the last update of the cardholder's address with server 49, merchants 12 that have not been previously presented to the cardholder 10 via a list, or merchants 12 that the cardholder 10 or Notification Module 304 have not yet notified of the address change (e.g., as per the Notification_Flag). Additionally, the presentation of the list to the cardholder 10 may be triggered by an event, such as, an update of the cardholder's personal data, e.g., address information, or be scheduled in accordance with a predetermined schedule, such as weekly or monthly. The list provided to the cardholder 10 may be provided as a report that is sorted and formatted and provides the cardholder 10 with information useful for contacting the merchants 12 to send the notifications of the address change, such as contact information.

With reference to FIG. 5C, in an embodiment, at step 520, the Notification Module 308 may prepare to notify payment system entities (e.g., merchants 12, merchant banks 18, issuing banks 16) of updated cardholder personal data, e.g., address information. In the current example, a notification record is entered into the Notification Table 216 for payment system entities that are to be notified of a personal data update. The payment system entities that that are to be notified by the Notification Module 308 may be filtered by a factor or combination of factors, such as, but not limited to: payment system entities that are enrolled in the PDU service, merchants 12 that have not successfully transacted a transaction since the date of the last update of the cardholder's address with server 49, merchants 12 that have a transaction history with the cardholder 10 that is not inactive for more than a threshold period of time, and/or the transaction was transacted with a cardholder 10 that is enrolled in the PDU service, and/or payment system entities that have not yet been notified of the address change (e.g., per the Notification_Flag).

Step 520 may be executed upon the occurrence of an event, for example, when a cardholder 10 enrolls with the PDU service or updates his address, or may be scheduled in accordance with a predetermined schedule, such as daily or monthly.

At step 522, notifications are prepared per the Notification Table 216 and transmitted to the payment system entities associated with the notification records to notify the payment system entities of the personal data update. The notifications may be prepared, scheduled, and transmitted by Notification Module 304. In an embodiment, the notifications may be provided to a system, such as an ABU system that transmits notifications to merchants 12 regarding updated billing information. The ABU system may send notifications of updated personal data in addition to updates of billing information. The notification message is sent to the payment system entities associated with records included in the Notification Table 216. The notification message may indicate that the personal data associated with the cardholder associated with a specified payment card is being updated. The notification message may further include the updated personal data. For example, merchants 12 may receive periodical billing updates combined with personal data updates for payment cards they have transacted with. The billing updates may be provided to the merchants 12 per a schedule or per a request. The billing updates may thus be supplemented with address update information for the cardholder 10 associated with the payment card.

At step 524, a record is added to the AVS Synch Update Table 214 for each merchant 12, merchant bank 18, and/or issuing bank 16 that is not enrolled in the PDU system, as indicated by the Enrolled_Flag or entries in the Enrolled Merchants Table 206.

At step 526, records stored in the AVS Synch Update Table 214 are added to the AVS Synch Table 212. A purpose of Steps 524 and 526 is to automatically synchronize an address update with the AVS Synch Table 212 in real time during a transaction, in order that a transaction will not be denied due to an address update by one entity, such as the payment network 20, issuing bank 16, merchant bank 18 or merchant 12 that has not yet been updated with another one of the entities.

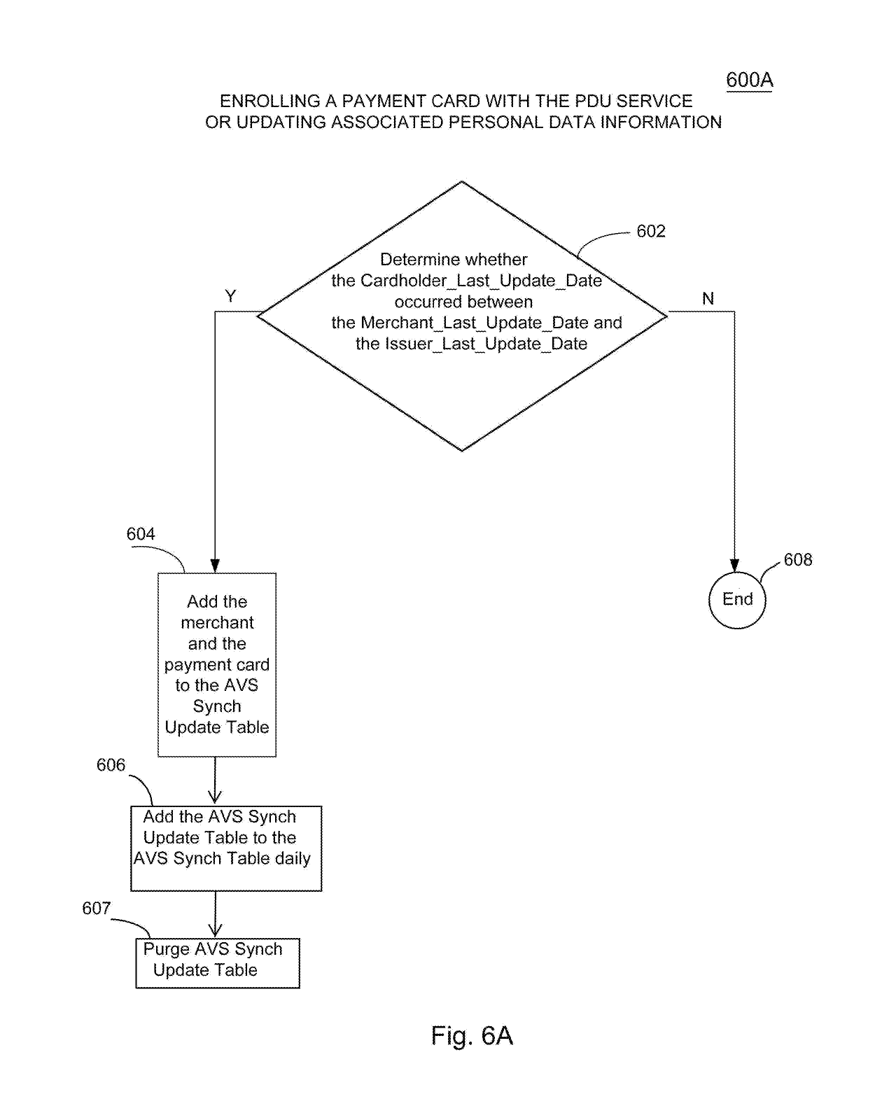

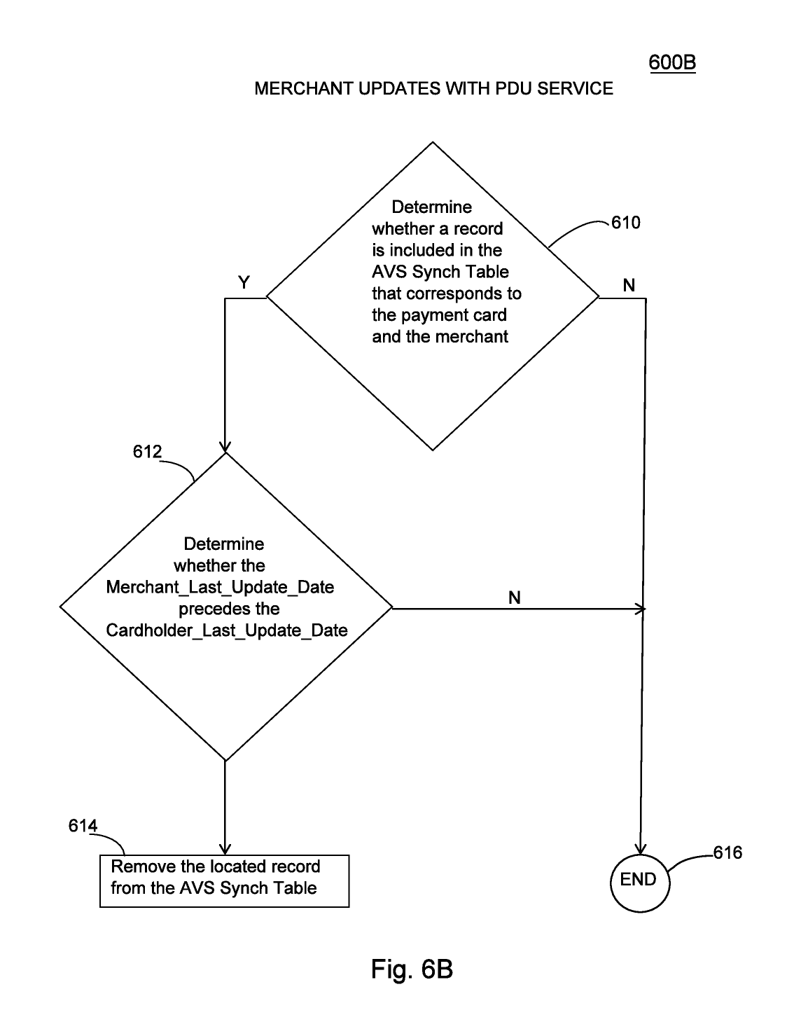

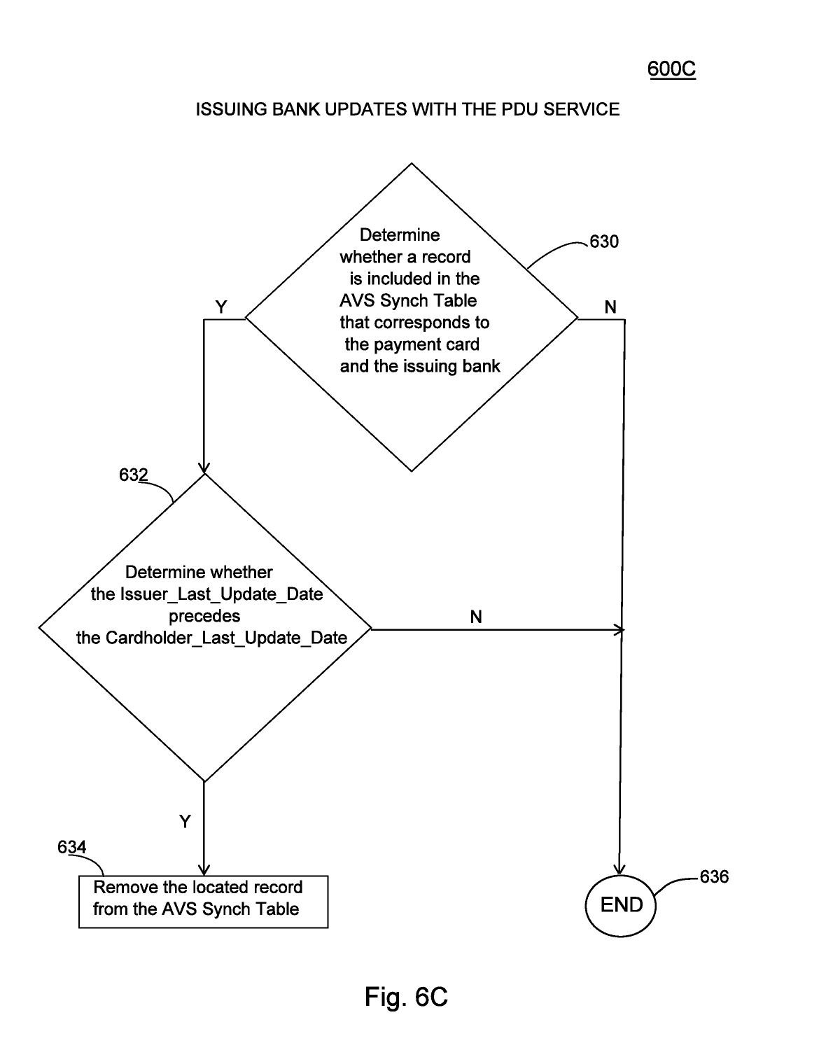

With reference to FIGS. 6A-6C, an example of operation of the AVS Synch Module 306 is shown by way of flow diagrams 600A, 600B, and 600C. The steps are provided by way of example and are not limiting. As described below, the AVS Synch Module 306 synchronizes personal data updates with a verification system that uses personal data, where the personal data is not limited to address data. Determination step 602 is executed when a cardholder 10, in connection with a payment card, enrolls with the PDU service or updates personal data information. At step 602, the AVS Synch Module 306 compares the Cardholder_Last_Update_Date stored in the Personal Data Table 202, Merchant_Last_Update_Date stored in the Enrolled Merchants Table 206, and the Issuer_Last_Update_Date stored in the BIN Table 204 to determine whether the Cardholder_Last_Update_Date occurred between the Merchant_Last_Update_Date and the Issuer_Last_Update_Date. If “Y,” step 604 is executed. If “N,” execution ends at step 608.

At step 604, AVS Synch Module 306 adds the merchant 12 and the payment card (e.g., the payment card's PAN) to the AVS Synch Update Table 214. At step 606, records stored in the AVS Synch Update Table 214 are added to the AVS Synch Table 212 on a daily basis. At step 607, after the update of AVS Synch Table 212 at step 606 is performed, the AVS Synch Update Table 214 is purged.

With reference to FIG. 6B, determination step 610 is executed when a merchant 12 accesses the PDU service in a manner that indicates the merchant received updated information related to the payment card. This may occur, for example, when the merchant 12 enrolls with the PDU service, updates information with the PDU service, accesses the PDU service, accesses the server 49 regarding the payment card in particular and/or any payment card. At determination step 610, the AVS Synch Module 306 determines whether a record is included in the AVS Synch Table 212 that corresponds to the payment card and the merchant 12. If the determination at step 610 is “Y,” then at determination step 612, the AVS Synch Module 306 determines whether the Merchant_Last_Update_Date precedes the Cardholder_Last_Update_Date. If the determination at step 610 is “N,” execution ends at step 616. If the determination at step 612 is “Y,” then at step 614, the record found in step 610 is removed from the AVS Synch Table 212. If the determination at step 614 is “N,” execution ends at step 616.

With reference to FIG. 6C, determination step 630 is executed when an issuing bank 16 accesses the PDU service in a manner that indicates the issuing bank 16 received updated information related to the payment card. This may occur, for example, when the issuing bank 16 enrolls with the PDU service, updates information with the PDU service, accesses the PDU service, accesses the server 49 regarding the payment card in particular and/or any payment card. At determination step 630, the AVS Synch Module 306 determines whether a record is included in the AVS Synch Table 212 that corresponds to the payment card and the issuing bank 16. If the determination at step 630 is “Y,” then at step determination 632, the AVS Synch Module 306 determines whether the Issuer_Last_Update_Date precedes the Cardholder_Last_Update_Date. If the determination at step 630 is “N,” execution ends at step 636. If the determination at step 632 is “Y,” then at step 634, the record found in step 630 is removed from the AVS Synch Table 212. If the determination at step 632 is “Y,” execution ends at step 636.

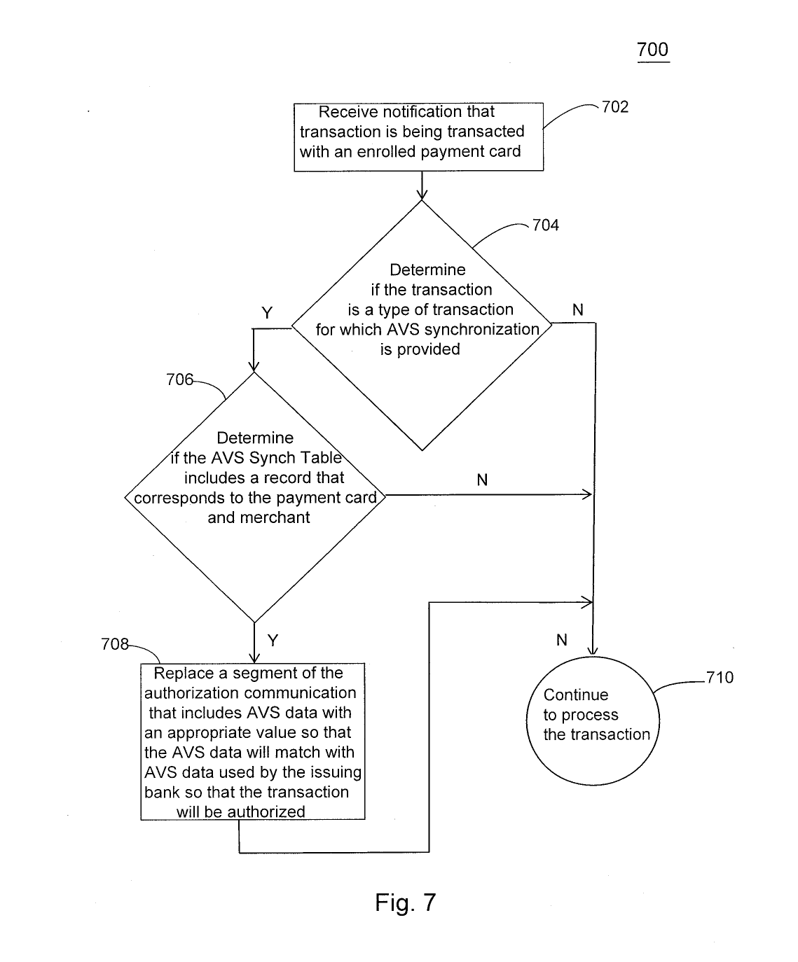

FIG. 7 shows a method by way of flow diagram 700, an example of operation of the AVS Synch Module 306 at the time a transaction is transacted for AVS synchronization. The steps are provided by way of example and are not limiting. At step 702, the AVS Synch Module 306 receives notification that a transaction is being transacted with an enrolled payment card. At determination step 704, the AVS Synch Module 306 extracts information about the transaction from the authorization communication shown by arrow 24 to determine if the transaction is a type of transaction for which AVS synchronization is provided, such as a transaction ordered via the internet (e.g., an e-commerce transaction), a mail order or telephone order (MOTO) transaction ordered via conventional mail or a telephone call, a transaction made via an automated fuel dispenser (AFD), or a recurring payment transaction. If the determination at step 704 is “Y,” then execution proceeds to step determination 706. If the determination at step 704 is “N,” execution proceeds to step 710 for continuing to process the transaction without AVS synchronization.

At determination step 706, the AVS Synch Module 306 uses extracted payment card identification information (e.g., the PAN) and merchant identification information from the authorization communication shown by arrow 24 to determine if the AVS Synch Table 212 includes a record that corresponds to the payment card and merchant 12. If so, this indicates that the payment card and the merchant 12 are not enrolled with the PDU service for automatic updating of address information, but the cardholder data has been updated since the issuing bank 16 or merchant 12 last updated the data that they store regarding cardholder personal data, and are available for AVS synchronization. If the determination at step 706 is “Y,” execution proceeds to step 708. If the determination at step 706 is “N,” this indicates that the payment card and/or the merchant 12 are enrolled with the PDU service and/or that the cardholder's most recent updates for the personal data has already been processed by the merchant 12, and execution proceeds to step 710 for continuing to process the transaction without AVS synchronization.

At step 708, a segment of the transaction message communicated by the communication shown by arrow 26 that includes verification data, e.g., the cardholder's address and/or zip code, is replaced with appropriate alternative personal data so that the verification data will match with verification data used by the issuing bank 16 or merchant bank 18 so that the transaction will be authorized.

In an example, verified historical address data stored in the Personal Data Table 202 may be the appropriate alternative personal data that is used to replace the verification data in a transaction message. A situation in which this is appropriate is when the verification data in the transaction message includes updated personal data, but the authenticating entity that is comparing its stored data to the transaction message is storing stale, historical personal data that has not been updated. When multiple, verified historical addresses are stored in the Personal Data Table 202, a date associated with the historical address may be used to determine which historical address to use as an appropriate value. A historical address having an associated Historical_Address_Last_Update_Date that most closely precedes the Last_Issuer_Update_Date stored in the BIN Table in association with the payment card may be selected to replace the verification data in the transaction message. If authentication fails, a different verified historical address may be used. Again the date may be used to select the next historical address to use. The process may be performed iteratively multiple times, e.g., until authentication is achieved, all of the verified historical addresses have been used as replacements, or a maximum allowed number of authentication trials has occurred.

In another situation, updated personal data stored in the Personal Data Table 202 may be the appropriate alternative personal data that is used to replace the verification data in a transaction message. In this situation, the verification data in the transaction message may be stale data that has not been updated, whereas the authenticating entity that is comparing its stored data to the transaction message is storing updated personal data. Thus, authentication may be achieved by replacing the stale verification data in the transaction message with updated personal data. An additional verification step may be made in this situation before making the replacement. The stale verification data in the transaction message may be compared with stored historical personal data. If there is not a substantial match, then the replacement may be disallowed. One having skill in the art is familiar with determining whether there is a substantial match. The criteria for matching may be designed to be strict, or relaxed to accommodate well known variations or clerical errors.

All or a combination of the steps of flow diagram 700 may be performed in real time, while a transaction is in process. Steps 702-708 may be triggered the first time that the transaction is initiated, or alternatively when an authorization failure occurs. The performance of steps 702-708 may be transparent to the cardholder 10 the merchant 12, merchant bank 18, and/or issuing bank 16. Any delay that may be caused to performing the authorization phase of the transaction may be short enough that it would not be noticed by the entities involved.

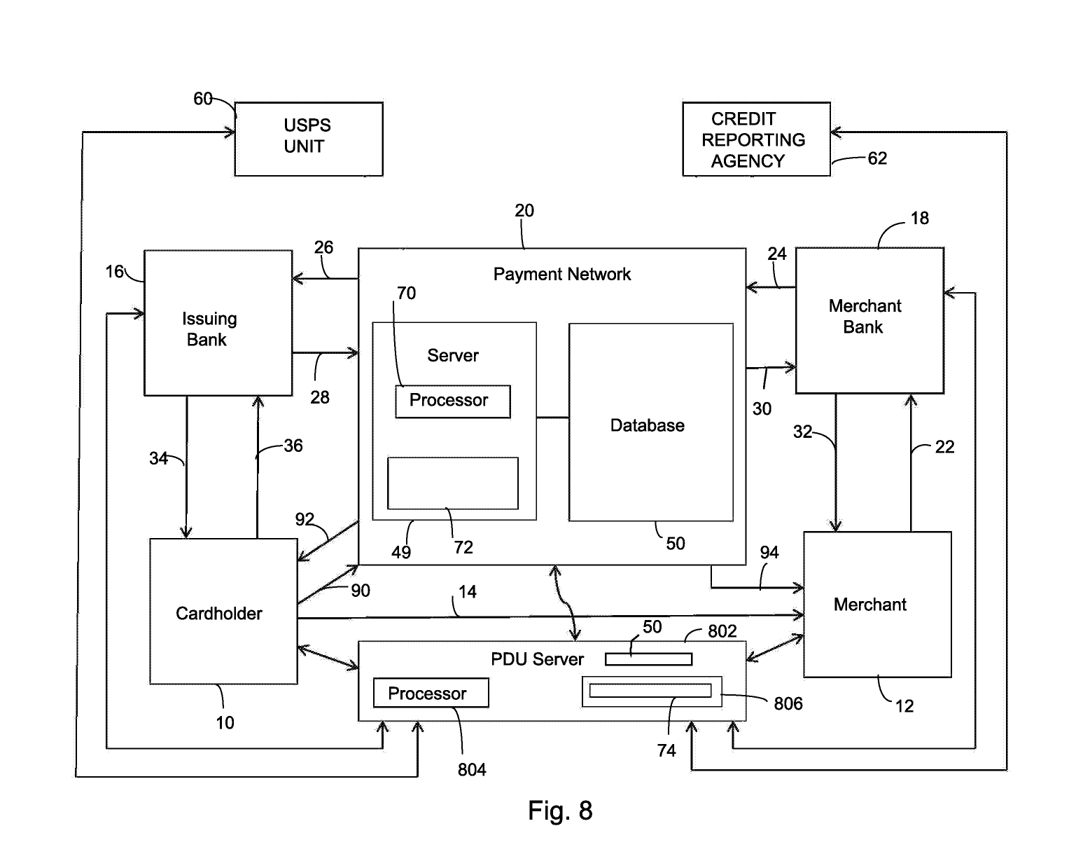

FIG. 8 shows an embodiment of another example of a card-based payment system 800. Card-based payment system 800 is similar to card-based payment system 100 shown in FIG. 1. The differences are now discussed.

In the card-based payment system 100, the PDU service and the AVS Synch service are provided by server 49 executing Service Modules 74. In the card-based payment system 800, a PDU server 802 is provided that is configured to be external from Payment Network 20. PDU server 802 may provide the PDU and AVS Synch Service to multiple payment networks 20 and their subscribers.

PDU server 802 includes a storage device 806 that stores Service Modules 74 and a processor 804 that executes Service Modules 74 for providing the PDU service and the AVS Synch service. PDU server 802 further includes or accesses database 50. The PDU server 802 is in data communication with one or more of the cardholders 10, merchants 12, issuing banks 16, merchant banks 18, payment networks 20, USPS unit 60, and/or Credit Reporting Agency 62, and is configured to receive and/or provide data to them in order to provide the PDU service and the AVS Synch service. The PDU server 802 thus is configured to provide the PDU service and the AVS Synch service to multiple payment networks 20. Additionally, PDU server 802 is configured to share information between parties based on security and privacy policies in accordance with governing laws and agreements it forms with entities that receive or transmit data with the PDU server 802.

Processor 804 executes the Service Module 74, including modules 302, 304 and 306, independent of administration from an issuing bank 16. Accordingly, in the course of executing any of the modules included in Service Module 74, processor 804 may exchange information with other entities of the payment system 800 and perform processing functions without the need for permission from an issuing bank 16, and without being controlled by an issuing bank 16, receiving input from an issuing bank 16, or providing output to the issuing bank 16.

It will be appreciated that the present disclosure has been described herein with reference to certain preferred or exemplary embodiments. The preferred or exemplary embodiments described herein may be modified, changed, added to or deviated from without departing from the intent, spirit and scope of the present disclosure, and it is intended that all such additions, modifications, amendments and/or deviations be included in the scope of the present disclosure.

What is claimed is:

1. A computer-implemented method for processing updated payment cardholder personal data, the method comprising:
receiving, by at least one processing device, updated personal data associated with a payment cardholder;
obtaining, by the at least one processing device, data identifying at least one payment system entity with which the payment cardholder has a transaction history; and
transmitting, by the at least one processing device, notification of the payment cardholder's personal data update to the identified at least one payment system entity,
wherein the receiving, obtaining, and transmitting by the at least one processing device are performed independent of administration by an issuing bank that issued a payment card to the payment cardholder.

2. The computer-implemented method according to claim 1, comprising the further steps of:
before transmitting the notification, providing, by the at least one processing device, identification of the identified at least one payment system entity to the payment cardholder; and
receiving from the payment cardholder, by the at least one processing device, a selection of at least one payment system entity for which the payment cardholder grants permission to transmit the notification,
wherein the notification is transmitted only to the selection of one or more payment system entity.

3. The computer-implemented method according to claim 1, wherein the updated personal data includes transaction verification data that is used to authorize a transaction.

4. The computer-implemented method according to claim 1, further comprising:
monitoring transactions transacted by the payment cardholder and storing associated transaction history data, wherein the transaction history data includes the payment card used, the merchant transacted with, and the date of the most recent transaction.

5. The computer-implemented method according to claim 4, further comprising storing with the updated personal data the most recent date that the personal data was updated,
wherein the notification is transmitted only to merchants associated with a transaction having an associated date of the most recent transaction that is before the date that the personal data was most recently updated.

6. The computer-implemented method according to claim 1, further comprising enrolling at least one entity, wherein the notification is transmitted only to or only on behalf of the enrolled at least one entity,
wherein the entity is selected from the group of entities consisting of a payment cardholder, merchant, merchant bank that participates in authorizing a transaction of an associated merchant and/or transfers funds involved in a transaction of an associated merchant, issuing bank that further participates in authorizing a transaction of an associated payment cardholder and/or transfers funds involved in a transaction of an associated payment cardholder, and payment network that provides a network of member payment cardholders, issuing banks, merchants and merchant banks via which members can transact payments with a payment card.

7. The computer-implemented method according to claim 1, wherein the notification includes the updated personal data.

8. The computer-implemented method according to claim 1, wherein the updated personal data includes at least a portion of contact information associated with the payment cardholder.

9. The computer-implemented method according to claim 1, further comprising:
maintaining a verification synchronization data structure storing at least one data item associated with a payment card and a merchant, wherein the merchant has not yet been notified regarding an update of personal data associated with a payment card holder of the payment card.

10. The computer-implemented method according to claim 9, further comprising:
enrolling at least one entity selected from the group of payment system entities consisting of a payment cardholder and a merchant,
wherein notification is transmitted to an identified merchant only if the identified merchant is enrolled;
the method further comprising storing a data item associated with the merchant and the payment card in the verification synchronization data structure if an identified merchant is not enrolled.

11. The computer-implemented method according to claim 9,
further comprising:
receiving notification of a transaction between a payment card and a merchant, wherein the transaction needs authorization;
accessing transaction data associated with the transaction, the transaction data including identification of the payment card and the merchant, and verification data associated with the payment card that is used to authorize the transaction;
determining if the verification synchronization data structure includes a data item that is associated with the identified payment card and the merchant; and
if so, replacing the verification data included in the transaction data with the updated personal data before a process to authorize the transaction.

12. The computer-implemented method according to claim 11, further comprising storing historical personal data that includes at least a portion of previously used contact information,
wherein instead of replacing the verification data with the updated personal
data, replacing the verification data with at least a portion of the historical personal data.

13. The computer-implemented method according to claim 12, wherein the historical personal data has an associated date indicating a date when it was relevant; and
the portion of the historical personal data is selected based on the associated date.

14. The computer-implemented method according to claim 11, the method further comprising:
storing historical personal data that includes at least a portion of previously used contact information associated with the payment cardholder; and only replacing the verification data in the transaction data when there is a substantial match between the historical personal data and the verification data included in the transaction data.

15. The computer-implemented method according to claim 14, wherein the historical personal data is obtained from credit report data provided by at least one credit reporting agency.

16. The computer-implemented method according to claim 11, wherein at least one of the receiving notification, the determining if the verification synchronization data structure, and the replacing is performed after a failed authorization attempt.

17. The computer-implemented method according to claim 11, wherein the notification of the transaction is received in real time while the transaction is in process.

18. The computer-implemented method according to claim 1, wherein the updated personal data is obtained from at least one of a payment cardholder action, data stored by the United States Postal Service, and a third party that is administered independently of the issuing bank.

19. The computer-implemented method according to claim 1, wherein the transmitting is responsive to receiving the update.

20. A computer-implemented method for processing updated payment cardholder personal data, the method comprising:
receiving, by a at least one processing device, updated personal data associated with a payment cardholder;
obtaining, by the at least one processing device, data identifying at least one payment system entity with which the payment cardholder has a transaction history; and
transmitting, by the at least one processing device, identification of each identified payment system entity,
wherein the receiving, obtaining, and transmitting by the at least one processing device are performed independent of administration by an issuing bank that issued a payment card to the payment cardholder.

21. The computer-implemented method according to claim 20, wherein the identification of the identified at least one payment system entity is provided to the payment cardholder.

22. A computer-implemented method for processing updated payment cardholder personal data, the method comprising:
accessing transaction data associated with a transaction between a payment card and a merchant that needs authorization, the transaction data including identification of the payment card, identification of the merchant, and verification data associated with the payment card that is used to authorize the transaction;
determining whether alternate personal data associated with a payment cardholder of the payment card is available; and
if the alternate personal data is available, replacing, before a process to authorize the transaction, the verification data included in the transaction data with a verification portion of the alternate personal data.

23. The computer-implemented method according to claim 22, wherein the verification portion of the alternate personal data includes at least a portion of contact information associated with the payment cardholder.

24. The computer-implemented method according to claim 22, wherein the alternate personal data is historical personal data that includes at least a portion of previously used contact information associated with the payment cardholder.

25. The computer-implemented method according to claim 24 wherein the historical personal data has an associated date indicating a date when it was relevant; and
the portion of the historical personal data is selected based on the associated date.

26. The computer-implemented method according to claim 22, the method further comprising:
storing historical personal data that includes at least a portion of previously used contact information associated with the payment cardholder; and only replacing the verification data in the transaction data when there is a substantial match between the historical personal data and the verification data included in the transaction data.

27. The computer-implemented method according to claim 26, wherein the historical personal data is obtained from credit report data provided by at least one credit reporting agency.

28. The computer-implemented method according to claim 22, wherein at least one of the accessing, the determining, and the replacing is performed after a failed authorization attempt.

29. The computer-implemented method according to claim 22, wherein the accessing the transaction data is performed in real time while the transaction is in process.

30. The computer-implemented method according to claim 22, wherein the alternate personal data is updated personal data.

31. A system for processing updated payment cardholder personal data, the system comprising:
a memory;
a computer device; and
a service module stored in the memory and executable by the computer device to:
receive updated personal data associated with a payment cardholder;
obtain data identifying at least one payment system entity with which the payment cardholder has a transaction history; and
transmit notification of the payment cardholder's personal data update to the identified at least one payment system entity,
wherein execution of the service module by the at least one processing device is independent of administration by an issuing bank that issued a payment card to the payment cardholder.

32. The system according to claim 31, wherein the updated personal data includes transaction verification data that is used to authorize a transaction.

33. The system according to claim 31, wherein the service module is further executable by the computer device to:
monitor transactions transacted by the payment cardholder; and
store associated transaction history data,
wherein the transaction history data includes the payment card used, the merchant transacted with, and the date of the most recent transaction.

34. The system according to claim 31, wherein the service module is executable by the computer device to: store associated with the updated personal data the most recent date that the personal data was updated; and
only transmit the notification to a payment system entity associated with a transaction having an associated date of the most recent transaction that is before the date that the personal data was most recently updated.

35. The system according to claim 31, wherein the service module is further executable by the computer device to maintain a verification synchronization data structure storing at least one data item associated with a payment card and payment system entity when the payment system entity has not yet been notified regarding an update of personal data associated with a payment card holder of the payment card.

36. The system according to claim 31, wherein the service module is further executable by the computer device to:
enroll at least one payment system entity selected from the group of entities consisting of a payment cardholder and a merchant; and
store a data item associated with the merchant and the payment card in the verification synchronization data structure if an identified merchant is not enrolled,
only transmit the notification to an identified merchant only when the identified merchant is enrolled.

37. The system according to claim 31, wherein the service module is further executable by the computer device to:
access transaction data associated with a transaction between a payment card and a merchant that needs authorization, the transaction data including identification of the payment card, the merchant, and verification data associated with the payment card that is used to authorize the transaction;
determine if the verification synchronization data structure includes a data item that is associated with the identified payment card and the merchant; and
if so, replace the verification data included in the transaction data with the updated personal data before a process to authorize the transaction.

38. The system according to claim 31, wherein the service module performs at least one of the accessing transaction data, the determining if the verification synchronization data structure, and the replacing after a failed authorization attempt.

39. A system for processing updated payment cardholder personal data, the system comprising a memory;
a computer device;
a service module stored in the memory and executable by the computer device to:
receive updated personal data associated with a payment cardholder;
obtain data identifying at least one payment system entity with which the payment cardholder has a transaction history; and
transmit identification of each identified payment system entity,
wherein execution of the service module by the at least one processing device is independent of administration by an issuing bank that issued a payment card to the payment cardholder.

40. The system according to claim 39, wherein the identification of the identified payment system entity is transmitted to the payment cardholder.

41. A system for processing updated payment cardholder personal data, the system comprising:
a memory;
a computer device;
a service module stored in the memory and executable by the computer device to:
access transaction data associated with a transaction between a payment card and a merchant that needs authorization, the transaction data including identification of the payment card, identification of the merchant, and verification data associated with the payment card that is used to authorize the transaction;
determine whether updated personal data associated with a payment cardholder of the payment card is available; and
if the updated personal data is available, replace, before a process to authorize the transaction, the verification data included in the transaction data with a verification portion of the updated personal data.

42. The system according to claim 41, wherein the verification portion of the updated personal data includes at least a portion of contact information associated with the payment cardholder.
